(19) United States
(12) Patent Application Publication
(10) Pub. No.: US 2018/0057647 A1
(43) Pub. Date: Mar. 1, 2018

(54) Wrapping Tape With Depressions

(71) Applicant: RedMonkey Sports, Inc., Lake Forest, CA (US)

(72) Inventor: Michael Vincent Nasco, Irvine, CA (US)

(21) Appl. No.: 15/691,724

(22) Filed: Aug. 30, 2017

Related U.S. Application Data
(60) Provisional application No. 62/382,222, filed on Aug. 31, 2016.

(51) Int. Cl. C08J 5/18

(52) U.S. Cl. CPC C08J 5/18; C08J 2383/04

(57) ABSTRACT

A wrapping tape may be formed of a length of elastically deformable material with a length, uniform width along the length, a top side, and a bottom side. A first edge of the tape is parallel to a second edge, thereby defining the uniform width. The tape includes a first depression formed into the top side and alongside the entire first edge. A second depression is also formed into the bottom side and alongside the entire second edge. The first depression on the top side is configured to be received into the second depression on the bottom side when the wrapping tape is wrapped around a cylinder, thereby overlapping the tape upon itself as it is wrapped. The depressions prevent the formation of a protruding bulge as the tape is overlapped.

### REFERENCE TO EARLIER APPLICATION

This application claims priority to U.S. Provisional Patent Application Ser. No. 62/382,222 filed on Aug. 31, 2016, the entire contents of which are expressly incorporated by reference herein.

### FIELD OF INVENTION

The invention is generally related to wrapping tapes for gripping surfaces such as handlebars. More specifically, the invention is related to an improved wrapping tape.

### TECHNICAL BACKGROUND

Many surfaces are routinely gripped during strenuous activities. For example, handles and grips on athletic equipment often require attention to their respective surface conditions in order to assure a user is capable of properly maintaining a sufficient grip. Oftentimes, attention to the surface conditions include cleaning, drying, or application of products that improve surface friction.

Regardless of the product or method used, the end goal is the same. The end goal is to ensure proper surface friction on the grip area thereby allowing the user to maintain sufficient control during the strenuous activity.

Known products that are used include application of an adhesive to the grip area. Adhesives improve the friction, however are difficult to remove. Over time, the adhesive ends up making the grip surface worse by retaining dust, dirt, and debris. Removal of the adhesive requires cleaning with solvents and time spent scrubbing.

Other products used to improve the friction of grip surfaces include wrapping tapes. Wrapping tapes are a good solution, yet require skill to function properly. When applying the wrapping tape, proper technique must be used to ensure a sufficient overlap of the tape thereby preventing it from moving on the grip. The wrapping tape also cannot be overlapped too much as it wastes material and builds up the surface of the grip producing a bulge.

What is therefore needed is a grip friction surface that may be easily applied and removed. What is also needed is a grip friction surface that does not require a high level of skill to apply properly. Finally, what is needed is a grip frictional material that improves on known solutions.

### OBJECT AND SUMMARY OF THE INVENTION

A wrapping tape may be provided to provide an improved grip to a cylindrical object such as bicycle handlebars or the like. The wrapping tape preferably is formed of a strip with a length, uniform width along the length, a top side, and a bottom side. A first edge of the tape is parallel to a second edge of the wrapping tape thereby defining the uniform width.

The wrapping tape also includes a center equidistant from the first edge and second edge. A left half is defined on one side of the center while a right half is defined opposite the left half. The right half and the left half of the wrapping tape are proportionally similar thereby allowing it to be wrapped about a cylindrical object uniformly.

The wrapping tape includes a first depression formed into the top side and alongside the entire first edge. A second depression is also formed into the bottom side of the tape and alongside the entire second edge. The first depression forms a first ridge on the top side thereby extending along the entire length of the wrapping tape parallel to the first edge. Similarly, the second depression forms a second ridge on the bottom side extending along the entire length of the wrapping tape parallel to the second edge.

When applying the wrapping tape onto a cylindrical object such as handlebars, the first depression of the top side is configured to be received into the second depression of the bottom side. Due to the first and second depressions lessening the thickness of the wrapping tape in their respective regions, the first depression is overlapped onto the second depression as the wrapping tape is wrapped about the cylindrical object thereby preventing formation of a protruding bulge.

The elastically deformable material is preferably stretchable as it is applied. In order to make the wrapping tape sufficiently stretchable, it is preferably made out of a silicone-based material. The wrapping tape is also preferably formed out of a uniform cross sectional area across the uniform width and along the entire length of the wrapping tape.

### BRIEF DESCRIPTION OF THE DRAWINGS

The present disclosure will be described hereafter with reference to the attached drawings which are given as non-limiting examples only, in which:

FIG. 1 shows a top view of a strip of wrapping tape according to an embodiment of the invention;

FIG. 2 shows a cross sectional view of the wrapping tape of FIG. 1 along line AA; and

FIG. 3 shows a perspective view of the wrapping tape of FIG. 1 being applied to a cylindrical object such as handlebars.

Corresponding reference characters indicate corresponding parts throughout the several views. The exemplifications set out herein illustrate an embodiment of the invention, and such exemplifications are not to be construed as limiting the scope of the invention in any manner.

### DETAILED DESCRIPTION

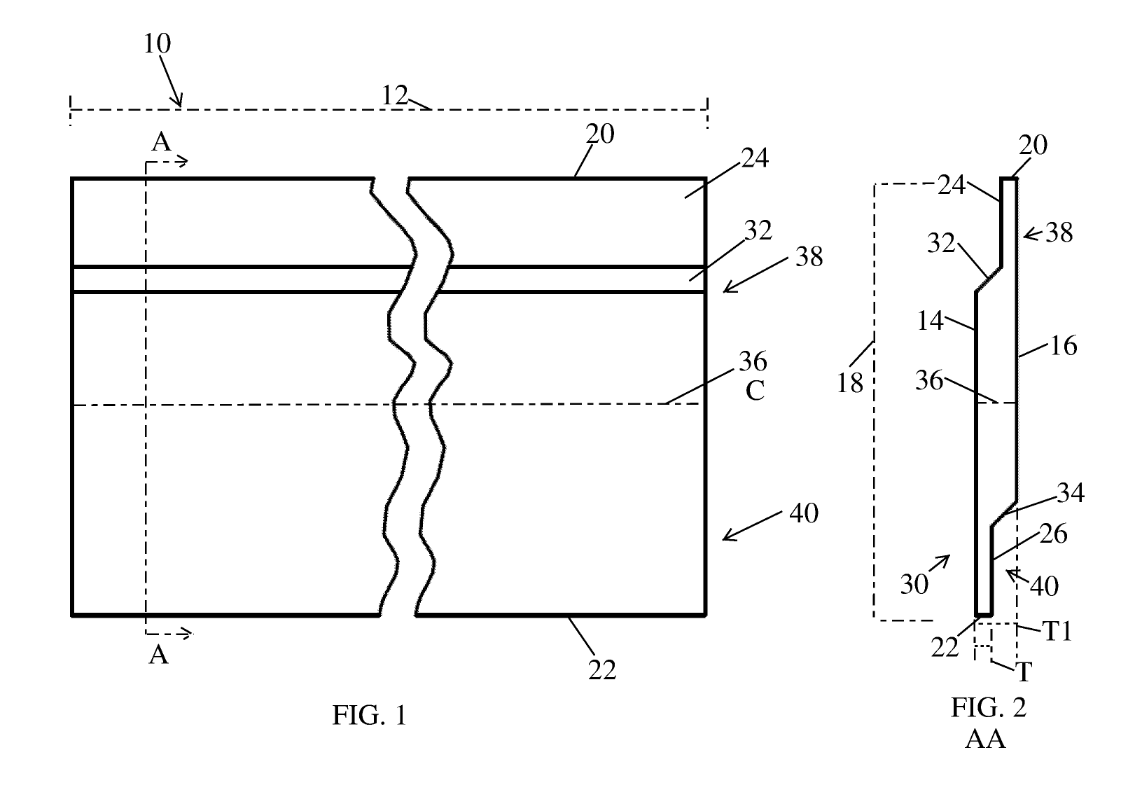

Referring to FIGS. 1 and 2, a strip of wrapping tape 10 is shown according to the invention. The wrapping tape 10 may be made out of any material including synthetic and natural materials. Preferably, the wrapping tape 10 is an elastically deformable material allowing it to be stretched and rebound to its original shape. Stretching allows the wrapping tape 10 to cling to a surface and retain its position after wrapping. Silicone is the preferred material for the wrapping tape as it is elastically deformable and sticks to itself during wrapping. The invention is not intended to be limited to silicone, as any other suitable material may be used. Other suitable materials include fabrics, plastics, synthetics, natural fibers, or any other known materials used to fabricate wrapping tapes.

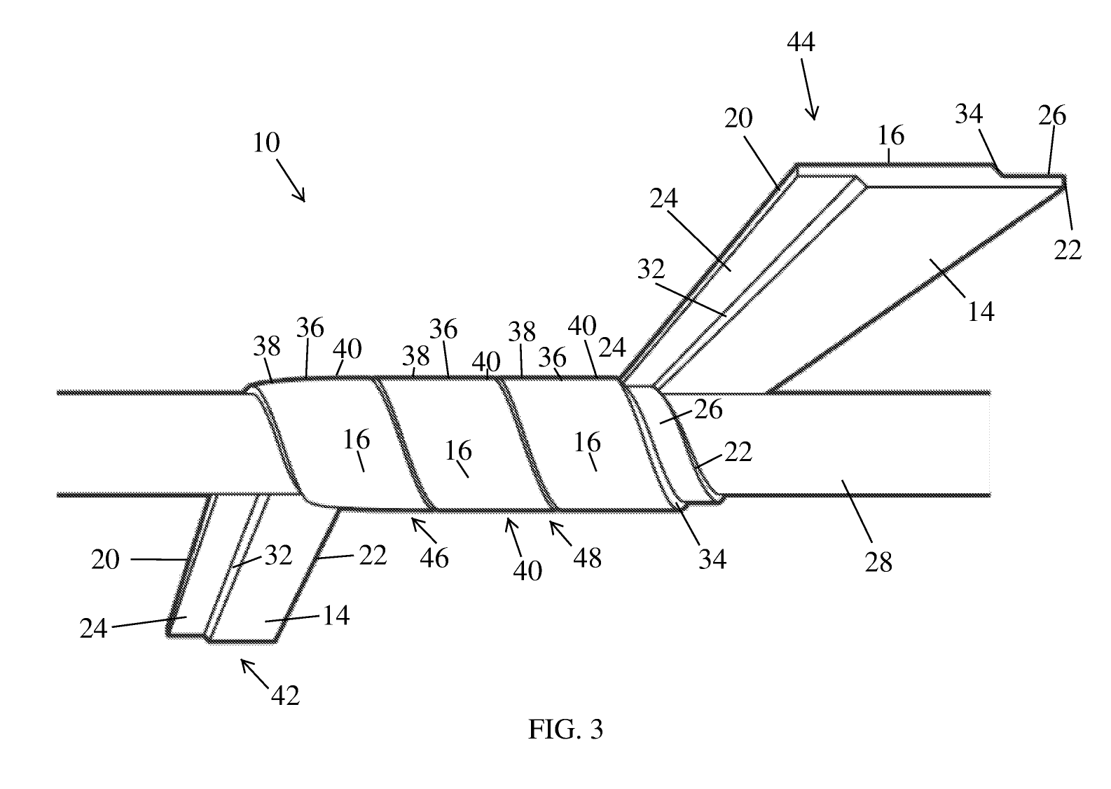

The wrapping tape 10 is formed to facilitate application when wrapping it around a cylindrical object 28 such as handlebars shown in FIG. 3. The wrapping tape includes a top side 14 and a bottom side 16. The edges of the wrapping tape 10 are defined by a first edge 20 and a second edge 22. The first edge 20 and the second edge 22 extend along the entire length 12 of the wrapping tape 10. The first edge 20 and the second edge 22 are also parallel along the entire length 12 thereby defining a uniform width 18.

A first depression 24 on the top side 14 defines a sunken-in area of the top side 14. The first depression 24 is of a thickness “T” as shown in FIG. 2 while the center 36 of the wrapping tape 10 is of a thicker thickness “T¹”. The reduced thickness of the first depression 24 defines the area of the first depression 24. The first depression extends uniformly along the length 12 of the wrapping tape 10 from the first edge 20 to a first ridge 32. The first ridge 32 inclines up from the surface of the first depression 24 to the center 36 surface of the top side 14 which is thicker.

FIG. 1 shows the top side 14 of the wrapping tape 10 which is divided into a left half 38 and a right half 40 by a center 36. FIG. 2 shows a cross section 30 of the same wrapping tape 10 where the bottom side 16 is also visible. Similar to the top side 14, the bottom side includes a second depression 26 along the length 12 and the second edge 22 of the wrapping tape 10. The second depression 26 has a reduced thickness “T” while the center 36 of the wrapping tape 10 is has a thicker thickness “T¹”. A second ridge 34 separates the thinner second depression 26 from the center 36.

The surface features of the top side 14 are proportionally similar to the surface features of the bottom side 16 such that they are inverses on one another. This allows the first depression 24 to nest within the second depression 26 while it is being wrapped around a cylindrical object 28 shown for example in FIG. 3.

Application of the wrapping tape 10 to a cylindrical object 28, as is shown in FIG. 3, begins by wrapping a first end 42 around the cylindrical object 28. While a straight cylindrical object 28 is shown, the wrapping tape 10 is pliable and stretchable to accommodate any surface that requires a hand-grip integration. Some examples of a cylindrical object 28 include golf club grips, tennis racket grips, steering wheel grips, baseball bat grips, and the like.

As the wrapping tape 10 is passed around the cylindrical object 28 to improve the hand-grip interaction, a portion of the top side 14 and the first depression 24 is secured against the cylindrical object 28 forming the first revolution 46. Following the first revolution 46, the bottom side 16 of the wrapping tape 10 is exposed and the second depression 26 is likewise exposed. When continuing to wrap the wrapping tape 10 for a second revolution 48, the first depression 24 is nested into the second depression 26 as shown throughout the even surface 40.

As previously mentioned, due to the decreased thicknesses of the first depression 24 and second depression 26 and also due to their similar proportions, an even surface 40 is created while overlapping the first depression 24 with the second depression 26. Preferably, the first edge 20 of the wrapping tape 10 is secured against second ridge 34 as the respective revolutions are made around the cylindrical object 28. This ensures even application of the wrapping tape 10 and uniformly spaced revolutions.

After a sufficient number of revolutions have been made around the cylindrical object 28, the second end 44 of the wrapping tape 10 may be trimmed off. Both the first end 42 and the second end 44 of the wrapping tape 10 may be secured to the cylindrical object with known fastening devices such as tapes and adhesives. These known fastening devices secure the revolutions around the cylindrical object 28 and keep it from unraveling.

The revolutions are also unlikely to unravel as the preferred material for constructing the wrapping tape 10, which is silicone, is tacky and sticks to itself. Therefore, as the revolutions are made around the cylindrical object, it is preferred to slightly stretch the wrapping tape 10 allowing its elastic deformation properties to continue to squeeze the cylindrical object 28 thereby retaining it in place.

As previously mentioned, other materials may also be used to construct the wrapping tape 10 and it is envisioned that adhesives or the like may be used to keep the wrapping tape 10 secured to the cylindrical object.

Additionally, while an even surface 40 is shown in FIG. 3 following creation of each revolution around the cylindrical object 28, it is envisioned that the thicknesses “T” and “T¹” as shown in FIG. 2 may be modified to produce any desired raised patterns. The raised patterns may be used for users who prefer to feel ridges or textures on the gripping area. Similarly, the wrapping tape 10 may include formed features such as divots, raised stripes, or other tactile features on the center 36 area between the first depression 24 and second depression 26 thereby adding a unique feel to the wrapping tape 10.

Although the present disclosure has been described with reference to particular means, materials and embodiments, from the foregoing description, one skilled in the art can easily ascertain the essential characteristics of the present disclosure and various changes and modifications may be made to adapt the various uses and characteristics without departing from the spirit and scope of the present invention as set forth in the following claims.

I claim:

1. A wrapping tape comprising;
an elastically deformable material formed with a length, a top side, a bottom side, and a uniform width;
a first edge and a second edge parallel to one another defining the uniform width;
a first depression formed into the top side and alongside the entire first edge;
a second depression formed into the bottom side and alongside the entire second edge; and
wherein the first depression of the top side is configured to be received into the second depression of the bottom side when the wrapping tape is wrapped around a cylindrical object.

2. The wrapping tape according to claim 1, wherein the elastically deformable material is a silicone-based material.

3. The wrapping tape according to claim 1, further comprising a uniform cross sectional area across the uniform width and along the entire length of the wrapping tape.

4. The wrapping tape according to claim 1, wherein the first depression forms a first ridge on the top side extending along the entire length of the wrapping tape and is parallel to the first edge.

5. The wrapping tape according to claim 1, wherein the second depression forms a second ridge on the bottom side extending along the entire length of the wrapping tape and is parallel to the second edge.

6. The wrapping tape according to claim 1, further comprising;
a center equidistant from the first edge and second edge;
a left half on one side of the center;
a right half opposite the left half; and
wherein the right half and the left half of the wrapping tape are proportionally similar.

7. The wrapping tape according to claim 6, wherein the first depression extends from the first edge towards the center on the top side and the second depression extends from the second edge towards the center on the bottom side.

8. A wrapping tape comprising;
an elastically deformable material formed with a length, a top side, a bottom side, a uniform width, and a uniform thickness along a center of the length;
a first edge and a second edge parallel to one another defining the uniform width;
a first depression formed into the top side and alongside the entire first edge forming a thickness of the wrapping tape less than the thickness at the center;
a second depression formed into the bottom side and alongside the entire second edge forming a thickness of the wrapping tape less than the thickness at the center; and
wherein the first depression of the top side is configured to be received into the second depression of the bottom side when the wrapping tape is wrapped around a cylinder without forming a raised edge from overlapping the first depression and the second depression.

9. The wrapping tape according to claim 8, wherein the elastically deformable material is a stretchable, silicone-based material.

10. The wrapping tape according to claim 8, further comprising a uniform cross sectional area across the uniform width and along the entire length of the wrapping tape.

11. The wrapping tape according to claim 8, wherein the first depression forms a first ridge on the top side extending along the entire length of the wrapping tape and is parallel to the first edge.

12. The wrapping tape according to claim 8, wherein the second depression forms a second ridge on the bottom side extending along the entire length of the wrapping tape and is parallel to the second edge.

13. The wrapping tape according to claim 8, further comprising;
a left half on one side of the center;
a right half opposite the left half; and
wherein the right half and the left half of the wrapping tape are proportionally similar.

14. The wrapping tape according to claim 8, wherein the first depression extends from the first edge towards the center and the second depression extends from the second edge towards the center on the bottom side.

15. A wrapping tape comprising:
a strip with a length, uniform width along the length, a top side, and a bottom side;
a first edge parallel to a second edge defining the uniform width;
a first depression formed into the top side and alongside the entire first edge;
a second depression formed into the bottom side and alongside the entire second edge;
wherein the first depression forms a first ridge on the top side extending along the entire length of the wrapping tape parallel to the first edge,
wherein the second depression forms a second ridge on the bottom side extending along the entire length of the wrapping tape parallel to the second edge; and
wherein the first depression of the top side is configured to be received into the second depression of the bottom side when the wrapping tape is wrapped around a cylindrical object.

16. The wrapping tape according to claim 15, wherein the elastically deformable material is a silicone-based material.

17. The wrapping tape according to claim 15, further comprising a uniform cross sectional area across the uniform width and along the entire length of the wrapping tape.

18. The wrapping tape according to claim 15, further comprising;
a center equidistant from the first edge and second edge;
a left half on one side of the center;
a right half opposite the left half; and
wherein the right half and the left half of the wrapping tape are proportionally similar.

19. The wrapping tape according to claim 16, wherein the elastically deformable material is configured to stretch as it is wrapped around a cylindrical object, nesting the first depression into the second depression.

20. The wrapping tape according to claim 15, wherein the first depression is overlapped onto the second depression as the wrapping tape is wrapped about the cylindrical object thereby preventing formation of a protruding bulge.
